(19) United States
(12) Patent Application Publication
(10) Pub. No.: US 2024/0142654 A1
(43) Pub. Date: May 2, 2024

(54) HIGH-FREQUENCY MAGNETOTELLURIC SOUNDING INSTRUMENT-BASED INVERSION METHOD FOR ENERGY SPECTRUM

(71) Applicant: INSTITUTE OF GEOLOGY AND GEOPHYSICS, THE CHINESE ACADEMY OF SCIENCES, Beijing (CN)

(72) Inventor: PENGFEI LIANG, Beijing (CN)

(21) Appl. No.: 18/107,505

(22) Filed: Feb. 9, 2023

Related U.S. Application Data
(63) Continuation of application No. PCT/CN2022/128170, filed on Oct. 28, 2022.

(51) Int. Cl. G01V 3/08; G01V 3/38

(52) U.S. Cl. CPC G01V 3/082; G01V 3/38

(57) ABSTRACT

The present disclosure is adapted to the field of geological exploration, and provides to a high-frequency magnetotelluric sounding instrument-based inversion method for energy spectrum, which provides that the energy spectrum obtained by transforming the time sequence signal in the high-frequency magnetotelluric data is defined as the model objective function and the data in the inversion objective function, to obtain the underground large-scale conductivity structure by inversion, which avoids the modification of the conventional detection method and detection instrument, and does not add extra expense and is easy to operate.

### CROSS-REFERENCE TO RELATED APPLICATIONS

This application is a continuation of co-pending International Patent Application Number PCT/CN2022/128170, filed on Oct. 28, 2022, the disclosure of which is incorporated herein by reference in its entirety.

### TECHNICAL FIELD

The present disclosure relates to the field of geological exploration technology, and more particularly to a high-frequency magnetotelluric sounding instrument-based inversion method for energy spectrum.

### BACKGROUND

In the conventional electromagnetic detection process, the detection frequency range of high-frequency magnetotelluric sounding instrument is 10 Hz-1000 Hz, the detection range of high-frequency magnetotelluric sounding instrument is all high-frequency of electromagnetic field, and the low-frequency of electromagnetic field is lacked, compared with the magnetotelluric frequency range of the traditional magnetotelluric instrument, which is 0.0001 Hz-1000 Hz. Since the low-frequency electromagnetic field information is closely related to the underground large-scale conductivity structure information, the lack of the low-frequency electromagnetic field information makes the inversion of magnetotelluric data easily result in local minima, and the accurate underground conductivity structure cannot be obtained. There are shortcomings in the prior art.

### SUMMARY

A purpose of the present disclosure is to extract low-frequency signal from the received high-frequency signal without modifying the conventional detection method and detection instrument, so as to meet the practical needs of inversion to obtain the underground large-scale conductivity structure.

The present disclosure provides a high-frequency magnetotelluric sounding instrument-based inversion method for energy spectrum, which includes the following steps:
a1. obtaining a time sequence signal by detecting the magnetotelluric field based on a high-frequency magnetotelluric sounding instrument;
a2. obtaining a signal frequency spectrum with frequency as abscissa and amplitude as ordinate by Fourier transforming on the time sequence signal;
a3. obtaining an energy spectrum by convolution operating on a full-band of the signal frequency spectrum;
a4. extracting the underground large-scale conductivity structure information by an inversion of a maximum value selected from the energy spectrum.

The present disclosure further provides a high-frequency magnetotelluric sounding instrument-based inversion method for energy spectrum, which includes the following steps:
a1. obtaining a time sequence signal by detecting the magnetotelluric field based on a high-frequency magnetotelluric sounding instrument;
a2. obtaining a signal frequency spectrum with frequency as abscissa and amplitude as ordinate by Fourier transforming on the time sequence signal;
a3′. obtaining an energy spectrum by Hilbert transforming on a full-band of the signal frequency spectrum;
a4. extracting the underground large-scale conductivity structure information by an inversion of a maximum value selected from the energy spectrum.

The present disclosure provides that the energy spectrum obtained by transforming the time sequence signal from the high-frequency magnetotelluric data is defined as the model objective function and the data in the inversion objective function, to obtain the underground large-scale conductivity structure by inversion, which avoids the modification of the conventional detection method and detection instrument, and does not add extra expense and is easy to operate.

### BRIEF DESCRIPTION OF DRAWINGS

FIG. 1 is a schematic diagram of a signal frequency spectrum obtained by Fourier transforming on a time sequence signal in the present disclosure.

FIG. 2 is a schematic diagram of a low-frequency energy spectrum by convolution operating the signal frequency spectrum shown in FIG. 1.

FIG. 3 is a flow chart of the high-frequency magnetotelluric sounding instrument-based inversion method for energy spectrum in the present disclosure.

### DETAILED DESCRIPTION OF EMBODIMENTS

In order to clarify the purpose, technical solutions and advantages of the present disclosure, the present disclosure is further described in detail below in combination with the accompanying drawings and embodiments. It should be understood that the specific embodiments described herein are intended to explain the present disclosure only and are not intended to limit the present disclosure.

The practice of the present disclosure is described in detail below in combination with the specific embodiment:

### EMBODIMENT

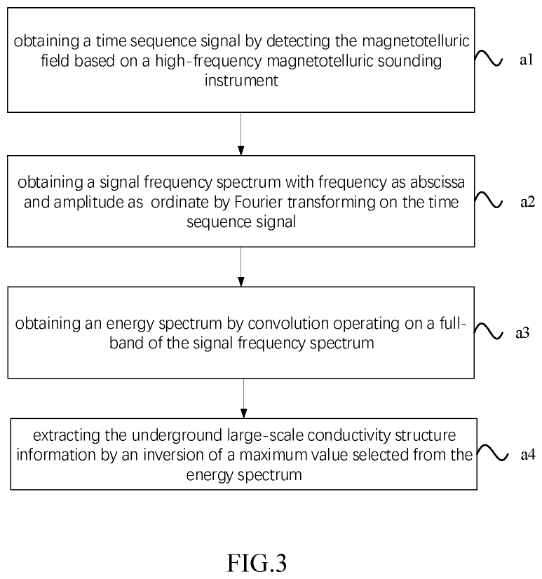

FIG. 3 illustrates an implementation process of a high-frequency magnetotelluric sounding instrument-based inversion method for energy spectrum provided by the embodiment 1 of the present disclosure. For illustrative purposes more easily, only portions related to the embodiment of the present disclosure are shown, as detailed below:

A high-frequency magnetotelluric sounding instrument-based inversion method for energy spectrum, which includes the following steps:

a1. obtaining a time sequence signal by detecting the magnetotelluric field based on a high-frequency magnetotelluric sounding instrument.

In the specific implementation process, the time sequence signal includes an underground large-scale conductivity structure information and an underground small-scale conductivity structure information.

a2. obtaining a signal frequency spectrum with frequency as abscissa and amplitude as ordinate by Fourier transforming on the time sequence signal;

Optionally, the signal frequency spectrum obtained by the Fourier transforming in step a2 illustrates the underground small-scale conductivity structure information, but cannot illustrate the underground large-scale conductivity structure information. An inversion interpretation can be performed based on the signal frequency spectrum. However, since the inversion tends to local minima, actually the accurate underground small-scale conductivity structure cannot be obtained, so the present disclosure needs to further process the signal frequency spectrum.

a3. obtaining an energy spectrum by convolution operating on a full-band of the signal frequency spectrum;

In specific implementation, the signal frequency spectrum in step a2 is in the convolution operation. The frequency range in the convolution operation is larger, and the error is smaller, so the present disclosure optionally performs convolution processing on the full-band of the signal frequency spectrum obtained in step a2.

Optionally, the energy spectrum obtained in step a3 can illustrate the low-frequency information of the magnetotelluric signal, so the underground large-scale conductivity structure information in the magnetotelluric signal is analyzed; based on the inversion of the energy spectrum, the underground large-scale conductivity structure can be obtained.

a4. extracting the underground large-scale conductivity structure information by an inversion of a maximum value selected from the energy spectrum.

In an alternative embodiment, the energy spectrum of step a4 and the signal frequency spectrum of the step a2 together illustrate the complete (large-scale and small-scale) underground conductivity structure information, and the inversion interpretation based on these two types of information is helpful to overcome the problem of local minima in the inversion, which is conducive to extracting the complete underground conductivity structure accurately.

In specific implementation, a simple time sequence signal can be defined to simulate the time sequence signal detected from the magnetotelluric sounding instrument, and the frequency information is: f₁=20 Hz, f₂=25 Hz; the expression of the time sequence signal to simulate the magnetotelluric field is:

s(t)=2 sin(2πf₁t)+2 cos(2πf₂t); (3),
where, f₁ and f₂ are the frequencies of two spikes in the frequency spectrum corresponding to the horizontal axis; t is the detection time; the frequency spectrum of the signal is obtained by Fourier transforming on the time sequence signal, as shown in FIG. 1.

Also, based on the definition of energy in magnetotelluric signal as the square of time sequence signal, that is:

p(t)=s1(t)*s1(t);
wherein, p(t) is the energy of the time sequence signal.

The energy spectrum including the low-frequency signal can be obtained by the convolution operating of the frequency spectrum of the time sequence signal.

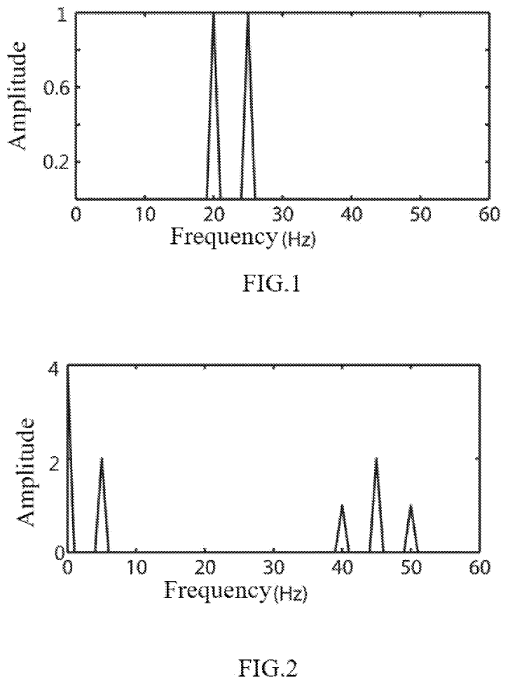

Optionally, as shown in FIG. 2, by observing the processed energy spectrum shown in FIG. 2, it can be found that the frequencies corresponding to the spikes of the energy spectrum have a high-frequency (40 to 50 Hz) region and a low-frequency (0 to 5 Hz) region. The low-frequency region corresponds to a frequency range much lower than the frequency of the source time sequence signal (20 Hz and 25 Hz). The frequency of the low-frequency signal appearing in the frequency spectrum of the energy is far lower the frequency of the time sequence signal but the amplitude is much higher than the intensity of the high-frequency signal. The signal-to-noise ratio in the low-frequency region is very high. Since the low-frequency signal includes the underground large-scale conductivity structure information, it can be inversed based on the low-frequency information in the spectrum energy to obtain the underground large-scale conductivity structure information, so as to provide support for the conventional high-frequency magnetotelluric inversion, and avoid the problem of local minima.

Further, the detection time of detecting the magnetotelluric field in step a1 is provided to be greater than or equal to 10 minutes and less than or equal to 20 minutes.

In specific implementation, when Fourier transforming on the time domain signal, the longer the length of the time domain signal is used, the higher the quality of the frequency spectrum signal is obtained after Fourier transforming. However, the time domain signal is longer, the actual detection time is longer, which is an inefficient choice in production. Therefore, providing the detection time to 10 minutes to 20 minutes can achieve a relative balance between the effects of high signal quality and detection economy (shorter detection time).

Further, in step a3, the calculation method of energy spectrum is as follows:

P(ω)=∫_{-∞}^{+∞}S1(η)S1(ω−η)dη (1)

wherein, ω is the frequency of energy, and ω is selected in the range of 0 Hz-60 Hz; η is the frequency of the signal; P(ω) is the energy spectrum; S1(η) is the signal frequency spectrum.

Optionally, in Formula (1), as the frequency of the signal, η is selected in the range of plus or minus infinity, but it is not possible to possess such a wide range in actual operation. Therefore, the selection of the value of η can be achieved according to the conventional convolution integral discretization operation.

In other embodiments, step a3′ substitutes for step a3.

In step a3′, the Hilbert transform is employed to process the signal frequency spectrum of the full-band into an energy spectrum.

Further, the calculation method of Hilbert energy spectrum is as follows:

$$H ( ω ) = \frac{- 1}{π} {\int }_{- ∞}^{+ ∞} \frac{S 1 ( η )}{ω - η} d η ; \qquad ( 2 )$$

where ω is the frequency of energy, and co is selected in the range of 0 Hz-60 Hz; η is the frequency of the signal; H(ω) is the Hilbert energy spectrum; S1(η) is the signal frequency spectrum. Employing the Hilbert transform to process the signal frequency spectrum involves less computation. Compared with the use of convolution operation, it can reduce the resource occupation of the processing equipment and improve the computing speed.

Optionally, in Formula (2), as the frequency of the signal, η is selected in the range of plus or minus infinity, but it is not possible to possess such a wide range in actual operation. Therefore, the selection of the value of η can be achieved according to the conventional convolution integral discretization operation.

Further, in step a3, the energy spectrum includes a plurality of different frequency ranges selected in the full-band of the signal frequency spectrum for calculation to obtain the spectrum corresponding to the selected frequency.

Optionally, ω in Formula 1 is the frequency of the energy. Each time the calculation of Formula (1) is completed, and a value (energy spectrum in FIG. 2) is obtained. As shown in FIG. 2, ω is selected in the range 0-60 Hz. ω is selected for several different values, and repeat the calculation of Formula (1) once for each value to obtain the energy spectrum as shown in FIG. 2.

As in FIG. 2, it is found that when the frequency is close to 0 Hz, the value of the energy spectrum is the maximum, with a strong anti-interference. Therefore, the energy spectrum of 0 Hz is selected for inversion to obtain the underground large-scale conductivity structure information. In specific implementation, the time sequence spectrums will be different because the high-frequency magnetotelluric signals detected are different. The final energy spectrums obtained are also different. Generally, after the energy spectrum calculation is completed, selecting one or several signal frequency spectrums with the maximum spectrum values as the data for inversion so that the accuracy of extracting the underground large-scale conductivity structure information can be improved.

The embodiments of the present disclosure are based on the traditional detection method and the conventional high-frequency magnetotelluric field signal measured by the high-frequency magnetotelluric sounding instrument, to improve low-frequency signal extraction. By the Fourier transform on the time sequence signal, further process signal frequency spectrum into energy spectrum, to obtain the low-frequency information included in the energy signal. There is no need to detect additional low-frequency information during the detection, and no need to modify the detection instrument, which not only retains the original detection method and instrument, but also does not add extra workload and working time. At the same time, it provides low-frequency signals for inversion, which can obtain the underground large-scale conductivity structure information, and provides support for the conventional high-frequency magnetotelluric inversion, to avoid the problem of local minima.

The above mentioned is only a practical embodiment of the present disclosure and is not intended to limit the present disclosure. Any modification, equivalent substitution and improvement within the spirit and principles of the present disclosure should be included in the protection scope of the present disclosure.

What is claimed is:

1. A high-frequency magnetotelluric sounding instrument-based inversion method for energy spectrum, comprising the following steps:
a1. obtaining a time sequence signal by detecting the magnetotelluric field based on a high-frequency magnetotelluric sounding instrument;
a2. obtaining a signal frequency spectrum with frequency as abscissa and amplitude as ordinate by Fourier transforming on the time sequence signal;
a3. obtaining an energy spectrum by convolution operating on a full-band of the signal frequency spectrum;
a4. extracting an underground large-scale conductivity structure information by an inversion of a maximum value selected from the energy spectrum.

2. The method, as recited in claim 1, wherein a detection time of detecting the magnetotelluric field in step a1 is provided to be greater than or equal to 10 minutes and less than or equal to 20 minutes.

3. The method, as recited in claim 1, wherein in step a3, a calculation method of the energy spectrum is as follows:
P(ω)=∫_{-∞}^{+∞}S1(η)S1(ω−η)dη (1),
wherein, ω is frequency of energy, co is selected in range of 0 Hz-60 Hz; η is frequency of signal, P(ω) is the energy spectrum, and S1(η) is the signal frequency spectrum.

4. The method, as recited in claim 3, wherein in step a3, the energy spectrum includes a plurality of spectrum corresponding to frequency ranges selected in the full-band of the signal frequency spectrum.

5. A high-frequency magnetotelluric sounding instrument-based inversion method for energy spectrum, comprising the following steps:
a1. obtaining a time sequence signal by detecting the magnetotelluric field based on a high-frequency magnetotelluric sounding instrument;
a2. obtaining a signal frequency spectrum with frequency as abscissa and amplitude as ordinate by Fourier transforming on the time sequence signal;
a3. obtaining an energy spectrum by Hilbert transforming on a full-band of the signal frequency spectrum;
a4. extracting the underground large-scale conductivity structure information by an inversion of a maximum value selected from the energy spectrum.
